(19) United States
(12) Patent Application Publication
(10) Pub. No.: US 2024/0035278 A1
(43) Pub. Date: Feb. 1, 2024

(54) ADJUSTABLE ROOF TRUSS BRACE

(71) Applicant: J N TEC LTD, Cambs (GB)

(72) Inventor: Jamie Nunn, Cambs (GB)

(21) Appl. No.: 18/227,351

(22) Filed: Jul. 28, 2023

(30) Foreign Application Priority Data
Jul. 29, 2022 (GB) 2211131.4

(51) Int. Cl. E04C 3/02; F16B 2/06

(52) U.S. Cl. CPC E04C 3/02; F16B 2/065; E04C 2003/026

(57) ABSTRACT

An adjustable roof truss brace for bracing a roof truss to a scaffold structure during a construction of a roof has an elongate body for extending between the scaffold structure and the roof truss and for supporting a roof truss in a substantially vertical position, the elongate body having a first end for positioning proximate the roof truss and a second end distal to the first end for disposing to the scaffold structure; a truss clamp for releasably coupling the roof truss brace to the roof truss, the truss clamp being disposed to the first end of the elongate body; and an adjustment mechanism configured to adjust a distance between the truss clamp and the second end of the elongate body

### CROSS REFERENCE TO RELATED APPLICATIONS

This application claims the benefit of priority to patent application GB2211131.4, filed on Jul. 29, 2022; the entirety of which is hereby incorporated by reference herein.

### BACKGROUND OF THE INVENTION

### Field of the Invention

The present invention relates to a roof truss brace and particularly but not exclusively to an adjustable roof truss brace.

### Background

Constructing a roof for a building such as a residential home requires the erection of a run of roof trusses. This process is time consuming and labor intensive, requiring multiple trades people working together, to ensure that each truss is installed vertically in the correct position safely.

The first truss, typically disposed to a gable end of a building, is erected substantially vertical (i.e. plumb) with two ends being located on wall plates. The weight of the truss as well as the wind may cause the truss to tip over or otherwise move which may pose a risk to the safety of the workers.

To hold the first truss in position during the construction, two braces are disposed between the first truss and a scaffold structure comprising a frame of scaffold tubes and working platforms. Each brace is typically a piece of timber nailed in position between a top chord (also known as a rafter, i.e. the angled portions of the truss) and a kickboard of a scaffold structure. The braces extend at a downward angle from the top chords to the kickboard, which can be a trip hazard as it significantly obstructs the work platform until removal.

The first truss may require repositioning during the construction process as it may have been move from their intended position. For example, the first truss may shift from the substantially vertical position and need re-levelling because of the wind, the process of applying the brace or insufficient support provided by the brace. This process can be difficult and time consuming, especially if the truss run is wholly or partially completed, because it requires the removal of the nailed braces before repositioning the first truss and subsequently re-nailing the brace in position.

Subsequent trusses in the run are typically positioned one by one moving away from the first truss at regular intervals. During this process, additional bracing timbers are fixedly attached between the trusses creating a rigid structure for the roof. Incorrect positioning or movement of the first truss may cause each subsequent truss to be incorrectly positioned.

It is an object of the present invention to reduce or substantially obviate the aforementioned problems.

### SUMMARY OF THE INVENTION

According to the present invention there is provided an adjustable roof truss brace for bracing a roof truss to a scaffold structure during a construction of a roof, the adjustable roof truss brace comprising:
an elongate body for extending between the scaffold structure and the roof truss to provide support, the elongate body including a first end for positioning proximate the roof truss and a second end distal to the first end for disposing to the scaffold structure;
a truss clamp for releasably coupling the roof truss brace to the roof truss, the truss clamp being disposed to the first end of the elongate body; and
an adjustment mechanism for adjusting a distance between the truss clamp and the second end of the elongate body.

An adjustable roof truss brace provides a means to, in use, level the roof truss to a substantially vertical position (i.e. make plumb) while bracing the truss to the scaffold structure. This improves safety and accuracy as there is no need to remove the brace prior to levelling.

A further advantage is it the adjustable roof truss brace can be easily and quickly fitted between the truss and scaffold structure without having to damage the truss or scaffold structure through nailing. This also allows the adjustable roof truss brace to be reusable between buildings being constructed.

The longitudinal extent, i.e. length, of the elongate body may be adjustable. That is to say that the distance between the first end of the elongate body and second end of the elongate body may be changed by increasing or decreasing the longitudinal extent of the elongate body. The change in the longitudinal extent of the elongate body changes the distance between the truss clamp and the second end of the elongate body.

The distance between the truss clamp and the second end of the elongate body may be adjustable in use and/or prior to use. The longitudinal extent of the elongate body may be adjustable in use and/or prior to use.

The adjustable roof truss brace in use is coupled to the truss and positioned so that it braces to the scaffold structure. That is to say that it may act as a brace between the roof truss and scaffold structure.

The adjustment mechanism may comprise an actuator configured to move the truss clamp with respect to the second end of the elongate body. A means to operate the actuator may be provided. The actuator may be disposed within the elongate body and the means to operate the actuator disposed external to the elongate body. The actuator may operate through rotation which causes movement of the truss clamp. The movement of the truss clamp may be achieved by the longitudinal extent of the elongate body changing. The actuator comprises a threaded rod configured to rotate in response to the means to operate the actuator. The actuator may be hand driven or motor driven.

An actuator allows for simple operation of the adjustment mechanism so that a user may easily level (i.e. make plumb) the roof truss. In some cases, the actuator may provide assistance to the user as it acts as a force multiplier.

The adjustment mechanism may be considered to provide fine adjustment of the distance between the truss clamp and the second end of the elongate body. In such cases, a fine adjustment mechanism provides for small incremental adjustments in distance or for adjustments which provide a substantially continuous change in distance. A substantially continuous change may be provided by an arrangement such as lead screw, such as a threaded rod, and nut or similar arrangements. A substantially continuous change may also be constrained to provide a certain about of travel.

The elongate body may be telescopic. The telescopic elongate body may comprise at least two sections. A first end section may comprise the first end of the elongate body. A second end section may comprise the second end of the elongate body. In some embodiments, the telescopic elongate body may comprise a middle or central section. The telescopic elongate body is one form which allows the longitudinal extent of the elongate body to be adjusted.

The adjustment mechanism may be configured to move at least one section of the telescopic elongate body, i.e. it causes the section to extend or retract. In some embodiments, the adjustment mechanism may be adapted to extend or retract the middle or central section.

An alerting means may be provided to indicate the extent of travel of the adjustment mechanism. Preferably, the alerting means may indicate the extent of travel of the fine adjustment mechanism. The alerting means may provide a visible indication. The alerting means may comprise two marks to show the extent of travel. In some embodiments, the two marks are provided on the middle section of the telescopic elongate body.

The elongate body may be a strong rigid material, for example metal such as steel.

A deployable portion may be provided for extending the elongate body between a compact configuration and an extended configuration. The truss clamp may be disposed to the deployable portion. The elongate body may comprise the deployable portion. The deployable portion may be the first end section of the telescopic elongate body.

The deployable portion allows the adjustable roof truss brace to be stored in a compact configuration which improves its transportability and maneuverability, for example, on scaffold structures. The deployable portion may be advantageously deployed to an extended configuration prior to use of the adjustable roof truss brace; this allows the longitudinal extent of the elongate body to be rapidly changed.

The deployable portion may be deployable to one of a plurality of discrete extended positions. The discrete extended positions may incrementally increase the longitudinal extent of the elongate body.

The deployable portion deployable to one of a plurality of discrete extended positions advantageously allows for more options in positioning of the adjustable roof truss brace as the elongate body can to be set to a number of longitudinal extents.

The deployable portion may also be considered as a way of coarsely adjusting the longitudinal extent of the elongate body and therefore the distance between the truss clamp and second end. Put another way, in some embodiments, the deployable portion may be considered a coarse adjustment mechanism. Advantageously, this provides for rapid changes in distance because the incremental changes in distance are greater when compared with the fine adjustment.

A locking means for securing the deployable portion in its extended position may be provided. The locking means may comprise a locking pin and a plurality of locking apertures for receiving the locking pin. Each discrete extended position may correspond to one locking aperture of the plurality of locking apertures. The locking apertures may be disposed along the elongate body. The locking apertures may be disposed to the deployable portion. A further locking aperture may be disposed to the middle section or second end section of the elongate body.

The truss clamp may be rotatable about a first axis. The truss clamp may be rotatable about a second axis, the second axis being substantially orthogonal to the first axis. The second axis may intersect with the first axis. Preferably, the intersect between the first axis and second axis is disposed within the first end of the elongate body.

The truss clamp may rotate about a pivot on the elongate body. A pivot arm may couple the truss clamp to the pivot. The pivot allows the pivot arm and truss clamp to rotate about an axis.

In some embodiments, the pivot arm may be substantially U-shaped, the substantially U-shaped pivot arm comprising a prong extending from each end of a cross piece. Each prong of the substantially U-shaped pivot arm may be coupled to the pivot on the elongate body. Advantageously, a substantially U-shaped pivot arm centralizes loading when the adjustable truss brace is in use.

In other embodiments, the pivot arm may be substantially L-shaped.

The truss clamp may rotate about a pivot on the pivot arm. That is to say that the truss clamp may be rotationally coupled to the pivot arm. Preferably, the truss clamp is pivotally coupled to the cross piece of the substantially U-shaped pivot arm. This allows the truss clamp to rotate about a further axis, i.e. the second axis.

A truss clamp which is cable of rotating about one or two axes has greater degrees of freedom to allow better positioning of the adjustable roof truss brace with respect to the truss.

A scaffold structure clamp for releasably coupling the adjustable roof truss brace to a scaffold structure may be provided. Preferably, the scaffold structure clamp may be disposed to the second end of the elongate body. The scaffolding structure clamp may be removable from the elongate body.

The scaffold structure clamp comprises a scaffold frame clamp for receiving a portion of the scaffold structure, preferably a cylindrical scaffold member. The scaffold clamp may comprise two clamping elements, one for receiving the elongate body and one for receiving a portion of the scaffold structure. The scaffold structure clamp may be movable along the elongate body.

The scaffold structure clamp may be pivotally mounted to the elongate body. The scaffold structure clamp may rotate about an axis which passes through a portion of the elongate body. That is to say, an axis which is orthogonal to longitudinal length of the elongate body. This is advantageous as it allows the scaffold clamp to swivel so that the adjustable roof truss brace can be better positioned with respect to the truss. Preferably the degree of rotation of the scaffold structure clamp is enough to provide for around a 45 degree angle between the elongate body of the adjustable roof truss brace and a scaffold element.

The scaffolding structure clamp advantageously allows the adjustable roof truss brace to be coupled to the scaffold structure in a releasably fixed manner. This prevents slipping which increases safety. Furthermore, the adjustable roof truss brace can be positioned so as to reduce hazards, such as trip hazards, as it can be attached to a scaffold frame rather than the kickboard.

In another aspect of the present invention there is provided a method of bracing a roof truss during construction of a building, the method comprising the steps of:
providing an adjustable roof truss brace according to an aspect of the present invention;
disposing the second end of the elongate body to a scaffold structure proximate the building being constructed;
adjusting the distance between the truss clamp and the second end using the adjustment mechanism; and
coupling the truss clamp to a roof truss being installed on the building being constructed.

A step of extending a deployable portion of the elongate body may be provided. The deployable portion may be deployable into one of a plurality of discrete extended positions. The step of extending a deployable portion may be performed prior to coupling the truss clamp to the roof truss.

A step of levelling the roof truss to a substantially vertical position may be provided. The step may be performed after the step of coupling the truss clamp. The step of levelling the roof truss may comprise operating the adjustment mechanism to adjust the distance between the truss clamp and the second end.

A step of coupling the second end of the elongate body to the scaffold structure may be provided. A scaffold structure clamp disposed towards the second end of the elongate body may be provided for coupling the second end of the elongate body.

### BRIEF DESCRIPTION OF SEVERAL VIEWS OF THE DRAWINGS

For a better understanding of the present invention, and to show more clearly how it may be carried into effect, reference will now be made by way of example only to the accompanying drawings, in which:

FIG. 1 shows a perspective view of an adjustable roof truss brace according to a first embodiment of the present invention;

FIG. 2 shows a top view of the adjustable roof truss brace in FIG. 1 in a compact configuration;

FIG. 3 shows a view of a substantially L-shaped pivot arm connecting the truss clamp to the adjustable roof truss brace in FIG. 1;

FIG. 4 shows a view of the second end of the adjustable roof truss brace in FIG. 1;

FIG. 5 shows a schematic view of the adjustable roof truss brace in FIG. 1 coupled to a roof truss and a scaffold structure; and

FIG. 6 shows a view of a substantially U-shaped pivot arm connecting the truss clamp to the adjustable roof truss brace.

### DETAILED DESCRIPTION OF THE ILLUSTRATED EMBODIMENTS

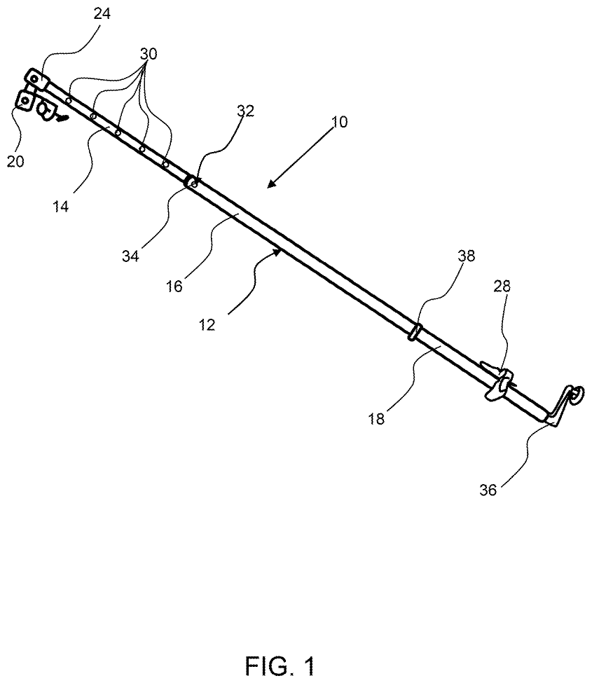

Referring to FIGS. 1 to 4, a first embodiment of an adjustable roof truss brace is generally indicated at 10.

A telescopic elongate body 12 comprised of three sections 14, 16, 18 is provided. The three sections are substantially cylindrical in shape. Each section may be substantially cylindrical metal tubes of different diameters. The first end section 12 is receivable in the middle section 16. The middle section 16 is receivable within the second end section 18. Each substantially cylindrical tube may comprise steel or a similar metal which is suitable to brace a portion of a roof truss to a scaffold structure. The material of each section may be the same or different.

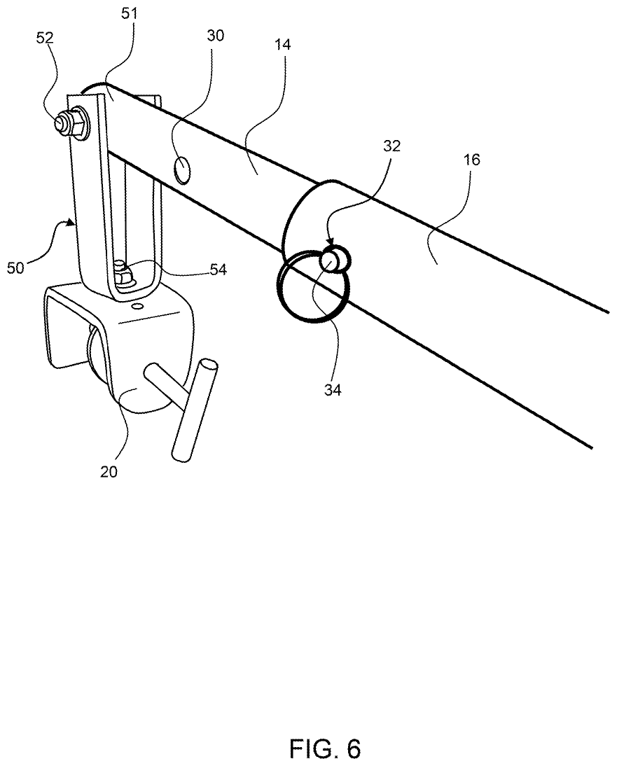

In the embodiment shown in FIGS. 1 to 4, the first end section 14 of the telescopic elongate body 12 includes a flattened end 19. The flattened end may be formed by nipping an end of the elongate body 12. However, in other embodiments such as that shown in FIG. 6, the first end section 14 of the telescopic elongate body 12 includes a tubular end 51, i.e. the first end section is substantially cylindrical in shape along its longitudinal length. That is to say, the first end section does not comprise the flattened end shown in FIGS. 1 to 4.

A truss clamp 20 is disposed towards a first end of the elongate body 12. The truss clamp 20 comprising a substantially U-shaped body having a base and two arms extending from opposites sides of the base. A truss receiving space is formed within the U-shaped body. A threaded rod extends through one the arms of the U-shaped body with a clamp head disposed at one end of the rod within the truss receiving space and an operatable handle disposed to the opposite end of the threaded rod.

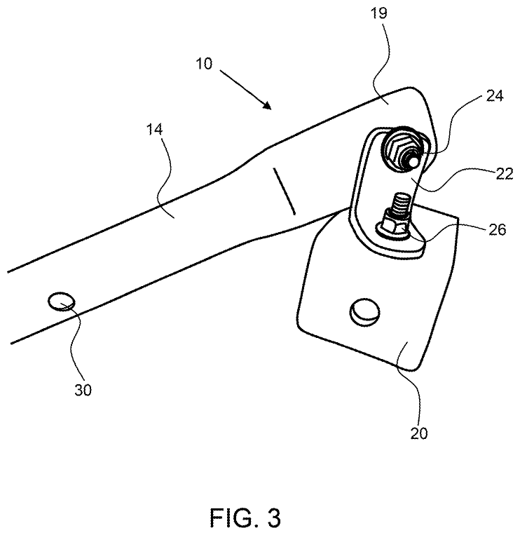

A first embodiment of a pivot arm is shown in FIG. 3. A second embodiment of a pivot arm is shown in FIG. 6 and discussed in detail further below.

The first embodiment of the pivot arm is a substantially L-shaped pivot arm 22. The substantially L-shaped pivot arm rotationally couples the truss clamp 20 to the flattened end 19 of the first end section 14. The L-shaped body includes a main body with one end rotationally coupled to the elongate body 12 and a flange extending from an end of the main body, the arm being rotationally coupled to the truss clamp 20.

A first rotational coupling 24 connects the main body of the substantially L-shaped pivot arm 22 to the flattened end 19 of the first end section 14. A first rotational axis is provided by the first rotational coupling 24. The first rotational axis extends through the main body of the L-shaped pivot arm and through the flattened end 19. The first rotational axis allows the truss clamp 20 to rotate about the first end of the elongate body 12.

A second rotational coupling 26 connects the flange of the substantially L-shaped pivot arm 22 to the truss clamp 20. A second rotational axis is provided by the second rotational coupling 26 and extends substantially orthogonal to the first rotational axis. The second rotational axis allowing the truss clamp 20 to swivel.

A scaffold structure clamp 28 is disposed towards a second end of the elongate body 12, the second end being distal to the first end. In the current embodiment, the scaffold structure clamp 28 is a removable pressed steel swivel coupler, the pressed steel swivel coupler comprising two coupler elements for receiving and clamping cylindrical tubes. One coupler element of the scaffold truss clamp 28 is coupled to the second end section 18 of the elongate body 12.

The two coupler elements are rotationally coupled together to allow for one element to swivel with respect to the other. The rotational coupling between the elements provides a rotational axis which extends through both coupler elements and the elongate body 12.

In other embodiments, the scaffold structure clamp 28 is not removable from the elongate body 12 and comprises a single clamping element for releasably coupling to a portion of a scaffold structure element.

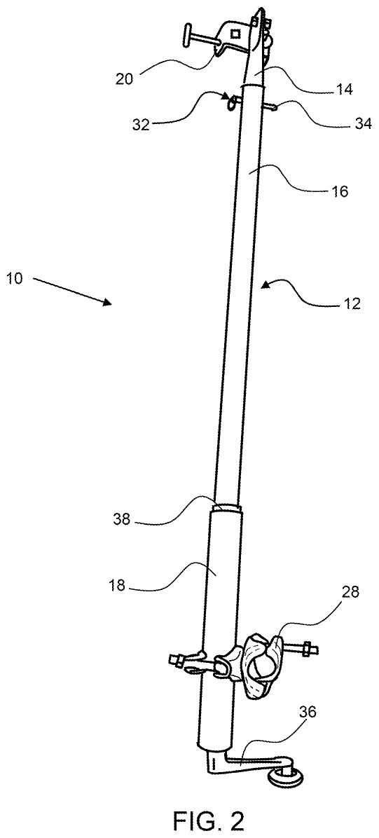

In the current embodiment, the first end section 14 is a deployable portion of the elongate body 12. In a compact configuration (shown in FIG. 2) the first end section 14 is received within the middle section 16 and is deployable to one of a plurality of extended positions (FIG. 1 shows an example extended position). In any of the extended positions an end part of the first end section 14 is disposed within the middle section 16.

A plurality of aperture pairs 30 are provided in the first end section 14 with each aperture pair 30 corresponding to one extended position. A further aperture pair (generally indicated at 32) is provided towards an end of the middle section 16. The aperture pairs in the first end section 14 and aperture pair in the middle section 16 receive a locking pin 34 to lock the first end section 14 in one of the extended positions.

An actuator assembly is provided as a mechanism to cause a portion of the middle section 16 to move, i.e. retract or extend, with respect to the second section 18. The actuator assembly comprises a handle 36 operably coupled to a threaded rod disposed within the elongate body 12. The threaded rod extends through the second end section 18 and at least partially into the middle section 16. At least one threaded coupling is affixed to an inner surface of the middle section 18 to couple the middle section to the threaded rod.

As a user rotates the handle 36, the middle section 16 is driven in a direction because rotation of the threaded rod causes the threaded coupling(s) to move linearly long the rod.

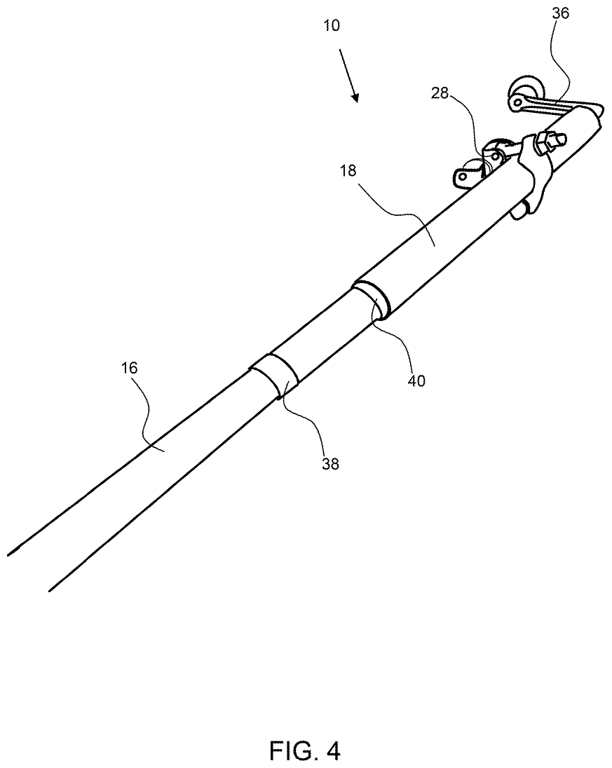

Two indicator marks 38, 40 (best seen in FIG. 4) are provided on the middle section 16 to indicate the extent of travel. The first mark 38 acts to alert a user that the middle section 16 should not be drawn into the second end section 18 any further. The second mark 40 acts to alert a user that if the middle section 16 is drawn out of the second end section 18 any further it may lead to an unsafe brace or disconnection from the threaded rod.

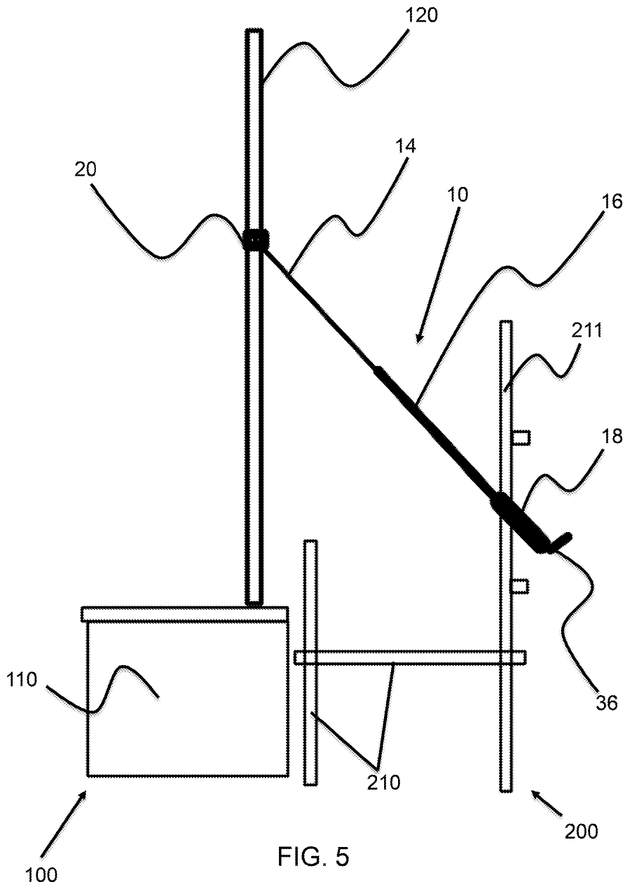

A method of bracing a roof truss during construction of a building will now be briefly described with reference to FIG. 5.

A building under construction is generally indicated at 100. The building has reached the stage where a run of roof trusses will be installed. A scaffold structure 200 will have been constructed in proximity to the wall 110 of the building. The scaffold structure 200 comprises a plurality of cylindrical scaffolding tubes 210 formed into a frame and extends to an appropriate height to allow for safe construction of the roof. A working platform is formed from wooden planks extending across horizontal scaffolding tubes. The working platform may have a kickboard installed to at least one side of the working platform.

In the current embodiment, the roof trusses are a standard construction. For example, a substantially triangular wooden frame comprising two top chords extending at angles for the ends of a bottom chord and webs extending therebetween.

A first roof truss 120 (show from the side in FIG. 5) is disposed to an upper surface of the wall 110 in a substantially upright, i.e. vertical position. The bottom chord is placed in the required position on the wall 110.

An adjustable roof truss brace 10 is provided. The adjustable roof truss brace 10 in FIG. 5 is that discussed above.

In the current embodiment, adjustable roof truss brace 10 is coupled to a substantially vertical cylindrical scaffold tube 211 through the use of scaffolding clamp 28 disposed to the second end of the elongate body 12. Preferably, the adjustable roof truss brace is coupled in a position along the scaffold tube 211 which will give a substantially 45 degree angle between the elongate body 12 and the substantially vertical scaffold tube 211 when the adjustable roof truss brace 10 is coupled to the roof truss 120.

Once the adjustable roof truss brace 10 is coupled to the scaffolding structure 200, the first end section 14 is deployed to one of the plurality of extended positions. This is achieved by removing the locking pin 34 and extracting the first end section 14 by an amount required. To lock the first end section 14 in the deployed position, the locking pin 34 is inserted through the aperture pair 32 on the middle section 16 and an aperture pair of the plurality of aperture pairs 30 in the first end section 14.

The extended position is chosen by the user so that the adjustable roof truss brace 10 can be coupled to the first roof truss 120 using the truss clamp 20. In some cases, the extended position may result in longitudinal extent of the elongate body 12 being more or less than is actually needed because of the coarse increments provided by the plurality of aperture pairs 30. In such cases, the handle 36 may be operated so that the actuator mechanism extends or retracts the middle section 16 to achieve the necessary longitudinal extent.

One of the top chords of the first roof truss 120 is received within the receiving space of the truss clamp 20. This may require rotating the truss clamp 20 about the first and/or second axis to position the truss clamp 20 in an appropriate position. The truss clamp 20 is then actuated so as to be releasably coupled to the top chord. The first roof truss 120 preferably being in a substantially upright position before being received in the receiving space of the truss clamp 20.

The positioned and coupled adjustable roof truss brace 10 now provides support to the roof truss 120. One or more additional adjustable roof truss braces 10 may also be fitted to the first roof truss 120 to provide support to other areas of the first roof truss.

Next the first roof truss 120 may be levelled, i.e. made plumb. Since the truss clamp 20 is coupled to the top chord of the first roof truss and the second end of the elongate body is coupled to the scaffold tube 211, any change in the longitudinal extent of the elongate body 12 will cause the coupled top chord to move. To adjust the longitudinal extent of the elongate body 12, the handle 36 of the actuator is operated to either extend or retract the middle section 16 as needed to substantially level the first roof truss 120. This process may be repeated with one or more additional adjustable roof truss braces.

Referring to FIG. 6, the second embodiment of the pivot arm is a substantially U-shaped pivot arm 50. In this embodiment, first end section 14 of the telescopic elongate body 12 includes a tubular end 51, i.e. the first end section 14 is substantially cylindrical in shape along its longitudinal length. Other than the tubular end 51, the first end section 14 is the same as that discussed above.

The substantially U-shaped pivot arm 50 and first end section 14 with tubular end 51 are used with the adjustable roof truss brace 10 discussed above.

The substantially U-shaped pivot arm 50 rotationally couples the truss clamp 20 to the tubular end 51 of the first section 14 of the telescopic elongate body 12. The substantially U-shaped pivot arm 50 includes two prongs and a cross piece, each prong extends from an end of the cross piece. The prongs are rotational coupled to the first end section 14. The cross piece is rotationally coupled to the truss clamp 20.

A first rotational coupling 52 connects both prongs of the substantially U-shaped pivot arm 50 to the first end section 14. The tubular end 51 of the first end section 14 is disposed between both prongs of the substantially U-shaped pivot arm 50. A first rotational axis is provided by the first rotational coupling 52. The first rotational axis extends through both prongs and through the tubular end 51 of the first end section 14. The first rotational axis allows the truss clamp to rotate about the first end of the elongate body 12.

A second rotational coupling 54 connects the cross piece of the substantially U-shaped pivot arm 50 to the truss clamp 20. A second rotational axis is provided by the second rotational coupling 54 and extends substantially orthogonal to the first rotational axis. The second rotational axis intersecting with the first rotational axis within the tubular end 51 of the first end section 14. The second rotational axis allowing the truss clamp 20 to swivel.

The embodiments described above are provided by way of example only, and various changes and modifications will be apparent to persons skilled in the art without departing from the scope of the present invention as defined by the appended claims.

What is claimed is:

1. An adjustable roof truss brace for bracing a roof truss to a scaffold structure during a construction of a roof, the adjustable roof truss brace comprising:
an elongate body for extending between the scaffold structure and the roof truss and for supporting a roof truss in a substantially vertical position, the elongate body including a first end for positioning proximate the roof truss and a second end distal to the first end for disposing to the scaffold structure;
a truss clamp for releasably coupling the roof truss brace to the roof truss, the truss clamp being disposed to the first end of the elongate body; and
an adjustment mechanism configured to adjust a distance between the truss clamp and the second end of the elongate body.

2. The adjustable roof truss brace as claimed in claim 1, in which the adjustment mechanism comprises an actuator configured to move the truss clamp with respect to the second end.

3. The adjustable roof truss brace as claimed in claim 1, in which the adjustment mechanism is configured to adjust the longitudinal extent of the elongate body.

4. The adjustable roof truss brace as claimed in claim 1, further comprising an alerting means indicating an extent of travel of the adjustment means.

5. The adjustable roof truss brace as claimed in claim 1, in which the elongate body comprises a deployable portion for extending the elongate body between a compact configuration and an extended configuration.

6. The adjustable roof truss brace as claimed in claim 5, in which the deployable portion is deployable to one of a plurality of discrete extended positions and in which the adjustable roof truss comprises a locking means for securing the deployable portion in one of the plurality of discrete extended positions

7. The adjustable roof truss brace as claimed in claim 6, in which the locking means comprises a locking pin and a plurality of locking apertures for receiving the locking pin, the locking apertures being disposed to the elongate body, each locking aperture corresponding to an extended position of the plurality of extended positions.

8. The adjustable roof truss brace as claimed in claim 5, in which the truss clamp is disposed to the deployable portion.

9. The adjustable roof truss brace as claimed in claim 1, in which the truss clamp is rotatable about a first axis disposed to the first end of the elongate body.

10. The adjustable roof truss brace as claimed in claim 9, in which the truss clamp is rotatable about a second axis substantially orthogonal to the first axis.

11. The adjustable roof truss brace as claimed in claim 9, in which one of a substantially U-shaped pivot arm and a substantially L-shaped pivot arm rotationally couples the truss clamp to the first end of the elongate body.

12. The adjustable roof truss brace as claimed in claim 1, further comprising a scaffold structure clamp pivotally mounted to the elongate body for releasably coupling the adjustable roof truss brace to the scaffold structure, the scaffold structure clamp being disposed towards the second end of the elongate body.

13. The adjustable roof truss brace as claimed in claim 12, in which the scaffold structure clamp is movable along the longitudinal length of the elongate body.

14. The adjustable roof truss brace as claimed in claim 12, in which the scaffold structure clamp is removable from the elongate body.

15. A method of bracing a roof truss during construction of a building, the method comprising the steps of:
providing the adjustable roof truss brace as claimed in claim 1;
disposing the second end of the elongate body to a scaffold structure proximate the building being constructed; and
adjusting the distance between the truss clamp and the second end using the adjustment mechanism;
coupling the truss clamp to a roof truss being installed on the building being constructed.

16. The method as claimed in claim 15, further comprising the step of extending a deployable portion of the elongate body into one of a plurality of discrete extended positions.

17. The method as claimed in claim 16, in which the step of extending the deployable portion is performed prior to coupling the truss clamp to the roof truss.

18. The method as claimed in claim 17, further comprising the step of levelling the roof truss to a substantially vertical position after the step of coupling the truss clamp.

19. The method as claimed in claim 18, in which the step of levelling the roof truss comprises operating the adjustment mechanism to adjust the distance between the truss clamp and the second end.

20. The method as claimed in claim 15, further comprising the step of coupling the second end of the elongate body to the scaffold structure using a scaffold structure clamp disposed to the second end of the elongate body.
